(19) United States
(12) Patent Application Publication
(10) Pub. No.: US 2022/0197629 A1
(43) Pub. Date: Jun. 23, 2022

(54) PROCESSING APPARATUS, APPARATUS, SYSTEM, AND METHOD

(71) Applicant: Canon Kabushiki Kaisha, Tokyo (JP)

(72) Inventor: Eiji Kadota, Kanagawa (JP)

(21) Appl. No.: 17/555,714

(22) Filed: Dec. 20, 2021

(30) Foreign Application Priority Data
Dec. 23, 2020 (JP) 2020-214162

(51) Int. Cl. G06F 8/65; G06F 3/14

(52) U.S. Cl. CPC G06F 8/65; G06F 3/14

(57) ABSTRACT

A processing apparatus capable of communicating with an external apparatus comprises: a generation unit configured to generate status information indicating whether or not it is possible to execute an update of a control program for controlling the processing apparatus; a transmission unit configured to transmit, to the external apparatus, the status information generated by the generation unit; and a reception unit configured to receive a request for execution of the update from the external apparatus based on the status information transmitted by the transmission unit indicating that the execution of the update is possible.

### BACKGROUND

### Field

The present invention relates to a processing apparatus, an apparatus, a system, and a method for controlling execution of update of a program.

### Description of the Related Art

Information apparatuses such as a personal computer and a smartphone that communicate with the server over a network may execute a process of acquiring update data of a peripheral device such as a printer that is connected to the information apparatus via a network from a server. The information apparatus then executes the update of the peripheral device based on the update data acquired from the server. Also, a peripheral device communicating with a server over the network may acquire update data of the peripheral device from the server and execute the update.

When updating a peripheral device as described above, there is normally a restriction that peripheral devices such as printers cannot receive an external operation request during updating. As a method of performing an update at appropriate timing during this restriction, there is known a method of executing an update of a peripheral device only when the update is permitted by all information apparatuses connected to the peripheral device (Japanese Patent Laid-Open No. 2010-277397).

Recently, there is demand for a function for appropriately executing an update of a peripheral device.

### SUMMARY

The present disclosure provides a processing apparatus, an apparatus, a system, and a method for enabling reception of a request for execution of an update in a state in which the update can be executed in an apparatus to be updated.

The present disclosure in one aspect provides a processing apparatus capable of communicating with an external apparatus, the processing apparatus comprising: a generation unit configured to generate status information indicating whether or not it is possible to execute an update of a control program for controlling the processing apparatus; a transmission unit configured to transmit, to the external apparatus, the status information generated by the generation unit; and a reception unit configured to receive a request for execution of the update from the external apparatus based on the status information transmitted by the transmission unit indicating that the execution of the update is possible.

According to the present invention, it is possible to execute an appropriate update process.

Further features of the present invention will become apparent from the following description of exemplary embodiments with reference to the attached drawings.

### BRIEF DESCRIPTION OF THE DRAWINGS

FIG. 1 is a diagram illustrating a configuration of an information processing system.

FIG. 2 is a diagram illustrating a configuration of an external apparatus.

FIG. 3 is a diagram illustrating a configuration of a processing apparatus.

FIG. 4 is a diagram illustrating processing between the processing apparatus and the server.

FIG. 5 is a diagram illustrating update data information.

FIG. 6 is a diagram illustrating processing between the processing apparatus, the external apparatus, and the server.

FIG. 7 is a diagram illustrating status information.

FIG. 8 is a diagram illustrating a user interface screen.

FIG. 9 is a diagram illustrating a user interface screen.

FIG. 10 is a diagram illustrating processing between the processing apparatus and the external apparatus.

FIG. 11 is a diagram illustrating processing between the processing apparatus and the external apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

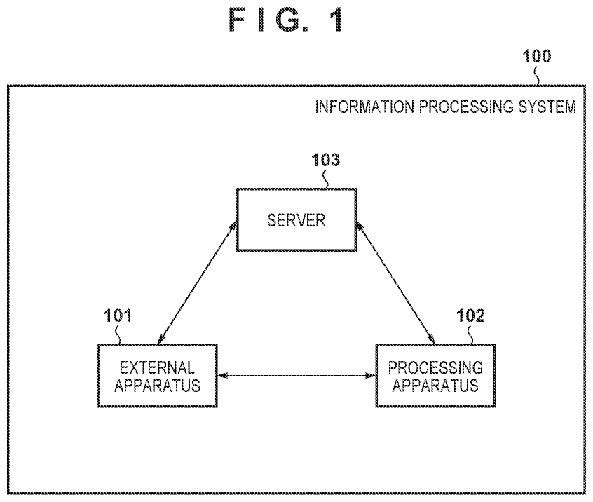

FIG. 1 is a diagram illustrating an example of a configuration of an information processing system 100 according to the present embodiment. The information processing system 100 includes an external apparatus 101, a processing apparatus 102, and a server 103. Although a smartphone is described as an example of the external apparatus 101 in the present embodiment, the present invention is not limited to this example, and various apparatuses such as a portable terminal, a notebook PC, a tablet terminal, a PDA (Personal Digital Assistant), and a digital camera can be used. Although a printer is described as an example of the processing apparatus 102 in the present embodiment, the present invention is not limited to this, and various types of apparatuses can be used as long as they can communicate with the external apparatus 101. For example, in the case of a printer, it is possible to apply the invention in an inkjet printer, a full-color laser beam printer, a monochrome printer, or the like. Further, the invention can be applied in not only a printer, but also in a copying machine, a facsimile apparatus, a portable terminal, a smartphone, a notebook PC, a tablet terminal, a PDA, a digital camera, a music playback apparatus, a television, and the like. In addition, the invention can be applied in an MFP (Multi Function Printer) having a plurality of functions such as a copying function, a FAX function, and a print function. The processing apparatus 102 and the external apparatus 101 can be interconnected via a network. The connection between the processing apparatus 102 and the external apparatus 101 may be a direct connection or a connection via an access point or the like. The external apparatus 101 and the processing apparatus 102 can be interconnected with the server 103 via a network. The communication between the respective apparatuses may include wired communication via a cable or the like.

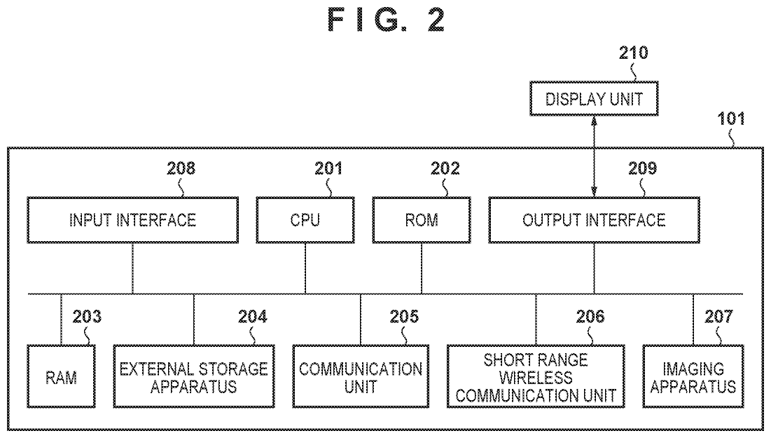

FIG. 2 is a diagram illustrating an example of the configuration of the external apparatus 101 and the server 103. Hereinafter, the external apparatus 101 will be described as a representative example of both apparatuses. The external apparatus 101 includes an input interface 208, a CPU 201, a ROM 202, a RAM 203, an external storage apparatus 204, an output interface 209, a display unit 210, a communication unit 205, a short range wireless communication unit 206, and an imaging apparatus 207.

The input interface 208 is an interface for receiving data input and operation instructions from a user, and includes a keyboard, a button, a touch panel, and the like. Note that the output interface 209 and the input interface 208 described later have the same configuration, and the output of the user interface screen and the reception of the operation from the user may be performed in the same configuration.

The CPU 201 is a system control unit, and controls the external apparatus 101 in an integrated manner. For example, the operation of the external apparatus 101 in the present embodiment is realized by the CPU 201 reading the program stored in the ROM 202 to the RAM 203 and executing it. The ROM 202 stores fixed data such as control programs executed by the CPU 201, data tables, and an embedded OS program. In the present embodiment, each control program stored in the ROM 202 executes software execution control such as scheduling, task switching, and interrupt processing under the control of the embedded OS stored in the ROM 202.

The RAM 203 consists of an SRAM (Static Random Access Memory) that requires a back-up power supply, or the like. Since data is held by a primary battery (not illustrated) for data backup, the RAM 203 can store data such as program control variables without volatilizing the data. Further, a memory area for storing the setting information of the external apparatus 101 and the management data of the external apparatus 101 is also provided in the RAM 203. The RAM 203 is also used as a main memory or a work memory of the CPU 201.

The external storage apparatus 204 stores a variety of applications and stores, for example, an application that provides a print execution function. The external storage apparatus 204 stores various programs such as a print information generation program that generates print information that can be interpreted by the processing apparatus 101, and an information transmission/reception control program for transmission/reception to/from the processing apparatus 102 connected via the communication unit 205. The external storage apparatus 204 stores various kinds of information used by the programs. Further, the image data acquired from another information processing apparatus or the Internet is stored through the communication unit 205.

The output interface 209 is a control interface for the display unit 210 to display data or notify the status of the external apparatus 101. The display unit 210 is configured by a light emitting diode (LED) or a liquid crystal display (LCD), and performs display of data and notifies the status of the external apparatus 101. Incidentally, by providing a soft keyboard having keys such as a numeric input key, a mode setting key, a determination key, and a cancel key, and a power key on the display unit 210, configuration may also be taken such that input is received from the user via the display unit 210.

The communication unit 205 is connected to the processing apparatus 102 or the like to execute data communication. For example, the communication unit 205 can be connected to an access point (not illustrated) in the processing apparatus 102. The communication unit 205 and an access point in the processing apparatus 102 are connected to each other so that the external apparatus 101 and the processing apparatus 102 can communicate with each other. The communication unit 205 may directly communicate with the processing apparatus 102 by wireless communication, or may communicate via the external apparatus 101 or an external access point (not illustrated) present outside the processing apparatus 102. As a wireless communication method, for example, Wi-Fi (Wire lessFidelity) (registered trademark) or Bluetooth is used. Further, as the external access point, for example, an apparatus of the wireless LAN router is used. In the present embodiment, a method in which the external apparatus 101 and the processing apparatus 102 are directly connected without intermediation of an external access point is referred to as a direct connection method. The system in which the external apparatus 101 and the processing apparatus 102 are connected to each other via an external access point is referred to as an infrastructure connection method.

The short range wireless communication unit 206 is configured to connect to the processing apparatus 102 or the like by short range wireless communication to execute data communication, and executes communication by a communication method different from that of the communication unit 205. The short range wireless communication unit 206 can be connected to the short range wireless communication unit 306 in the processing apparatus 102. In the present embodiment, BLE (Bluetooth Low Energy) is used as a communication method of the short range wireless communication unit 206. Each communication module of a Bluetooth device is assigned a BD address (Bluetooth Device Address) which is apparatus-specific identification information.

The imaging apparatus 207 is an apparatus for converting the image signal imaged by the image sensor into digital data Digital data is first stored in the RAM 203. Then, it is converted into a predetermined image format by a program executed by the CPU 201, and stored in the external storage apparatus 204 as image data. The configuration of the external apparatus 101 is not limited to the configuration illustrated in FIG. 2, and may appropriately include a configuration corresponding to a function executable by the external apparatus 101. The external apparatus 101 and the server 103 may have different configurations. For example, the server 103 may be configured to not include the imaging apparatus 207.

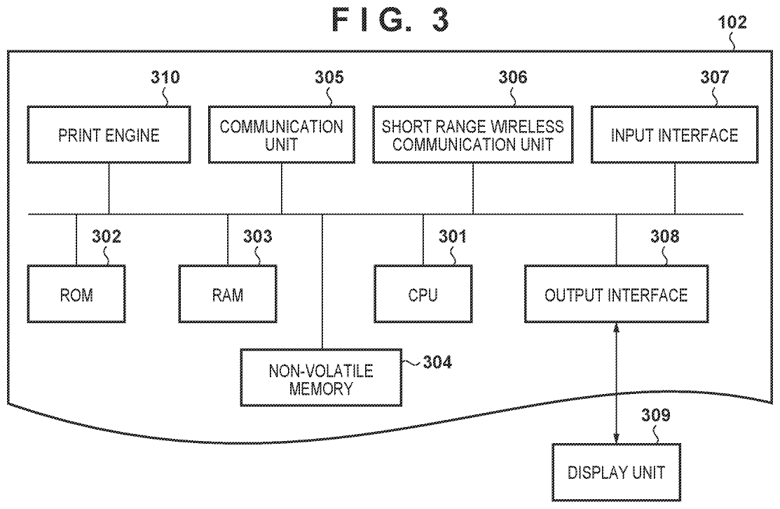

FIG. 3 is an example of a diagram illustrating a configuration of the processing apparatus 102. The processing apparatus 102 includes a CPU 301, a ROM 302, a RAM 303, a non-volatile memory 304, a communication unit 305, a short range wireless communication unit 306, an input interface 307, an output interface 308, a display unit 309, and a print engine 310.

The communication unit 305 includes an access point for connecting to an apparatus such as the external apparatus 101 as an access point inside the processing apparatus 102. The access point can be connected to the communication unit 205 of the external apparatus 101. The communication unit 305 may communicate directly with the external apparatus 101 by wireless communication, or may communicate via an external access point. Wi-Fi or Bluetooth, for example, is used as the communication method. The communication unit 305 may include hardware that functions as an access point, or may include software that functions as an access point.

The RAM 303 consists of a DRAM (Dynamic Random Access Memory) that requires a back-up power supply, or the like. Note that since data is retained by a power supply (not illustrated) being supplied for data backup, the RAM 303 can store data such as program control variables without volatilizing the data. The RAM 303 is also used as a main memory or a work memory of the CPU 301, and is used, for example, as a reception buffer for temporarily storing print information received from the external apparatus 101 or the like.

The ROM 302 stores fixed data such as control programs such as firmware that are executed by the CPU 301, data tables, and an OS program. In the present embodiment, each control program stored in the ROM 302 executes software execution control such as scheduling, task switching, and interrupt processing under the control of the embedded OS stored in the ROM 302. Further, a memory area for storing data that needs to be held even when power is not supplied, such as management data of the processing apparatus 102, is also provided in the ROM 302. The ROM 302 also stores a ROM version of a firmware. As will be described later, status information of the processing apparatus 102 is stored in the ROM 302. The status information is information indicating whether or not the processing apparatus 102 is in a state in which updating of the firmware can be executed, and is generated based on free space of the memory of the processing apparatus 102.

The CPU 301 is a system control unit, and controls the processing apparatus 102 in an integrated manner. For example, the operation of the processing apparatus 102 in the present embodiment is realized by the CPU 301 reading the program stored in the ROM 302 to the RAM 303 and executing it, for example.

The print engine 310 forms an image on a recording medium such as paper using a print agent such as ink based on print information stored in the RAM 303 or a print job received from the external apparatus 101, and outputs a print result. Since a print job transmitted from the external apparatus 101 or the like is generally required to have a large amount of transmission data and high-speed communication, the print job may be received by the communication unit 305 which can communicate at a higher speed than the short range wireless communication unit 306.

The input interface 307 is an interface for receiving data input and operation instructions from a user, and includes a keyboard, a button, a touch panel, and the like. Note that the output interface 308 and the input interface 307 described later have the same configuration, and the output of the user interface screen and the reception of the operation from the user may be performed in the same configuration. The output interface 308 is a control interface for the display unit 309 to display data or notify the status of the processing apparatus 102.

The display unit 309 is configured by a light emitting diode (LED) or a liquid crystal display (LCD) or the like, and displays data or notifies the status of the processing apparatus 102. Incidentally, by providing a soft keyboard having keys such as a numeric input key, a mode setting key, a determination key, and a cancel key, and a power key on the display unit 309, configuration may also be taken such that input is received from the user via the display unit 309.

The non-volatile memory 304 is comprised of devices such as EEPROM (Electrically Erasable Programmable Read-Only Memory), flash memory, and the like. The non-volatile memory 304 is used, for example, to store data such as setting values of the processing apparatus 102 that must be held even when the processing apparatus 102 is not powered.

The short range wireless communication unit 306 is a configuration for connecting by short range wireless communication with the external apparatus 101 or the like. The CPU 301 and the short range wireless communication unit 306 communicate with each other through a bus interface such as an I2C (Inter-Integrated Circuit), and the external apparatus 101 can be accessed through the short range wireless communication unit 306. The processing apparatus 102 may be equipped with a memory such as an external HDD or an SD card as an optional device, and the information of the processing apparatus 102 may be stored in the memory. The configuration of the processing apparatus 102 is not limited to the configuration illustrated in FIG. 3, and may appropriately include a configuration corresponding to a function executable by the external apparatus 101.

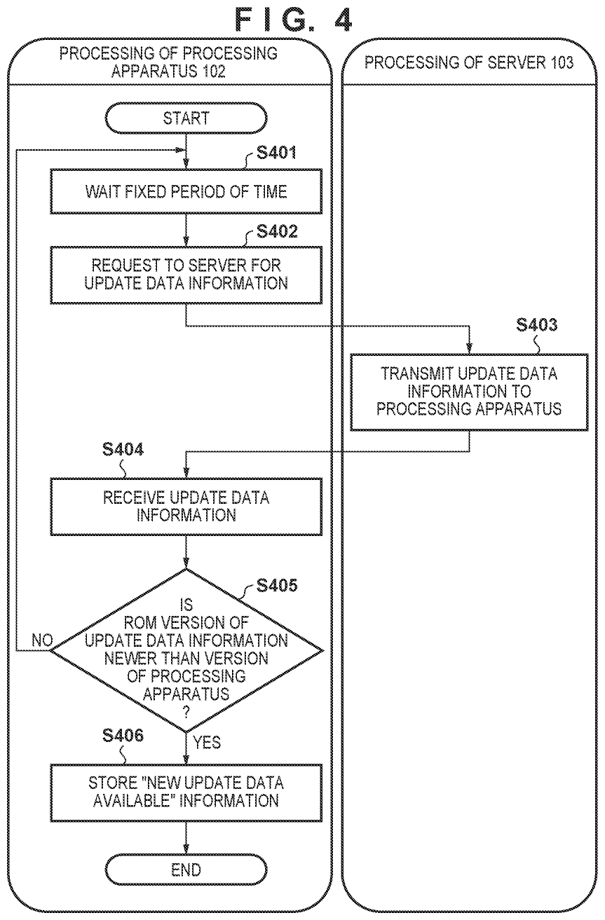

Referring to FIGS. 4, 5, 6, 7, 8, and 9, a process for controlling an update of a control program in the present embodiment will be described. For example, firmware may be updated in accordance with updating of functions of the processing apparatus 102. At this time, a user instructs execution of the update from the external apparatus 101, which may be his/her own smartphone or the like, when he/she desires to execute the update of the processing apparatus 102. However, the update is not executed unless the processing apparatus 102 is in a state in which an update can be executed when the instruction to execute the update is made. For example, when a restart is performed in accordance with the execution of the update of the processing apparatus 102, data stored in the volatile memory may be erased against the user's intention.

Therefore, in the present embodiment, the processing apparatus 102 generates status information indicating whether or not the update can be executed based on the state of the processing apparatus 102 itself, and transmits the status information to the external apparatus 101. The external apparatus 101 displays an update execution screen based on an indication that the status information received from the processing apparatus 102 is that it is possible to execute the update. In the present embodiment, such a configuration allows the processing apparatus 102 to receive a request to execute an update at a timing when the update can be executed. The external apparatus 101 can also display the update execution screen at an appropriate timing when the update can be executed by the processing apparatus 102.

First, with reference to FIG. 4, a process in which the processing apparatus 102 acquires information (update data information) related to the update data and stores the information of “new update data available” in the processing apparatus 102 will be described. Note that “new update data available” means that there is new update data on the server 103. The process of FIG. 4 may be initiated, for example, after the processing apparatus 102 is powered on.

In step S401, the processing apparatus 102 waits for a fixed period of time prior to requesting update data information from the server 103. By waiting for a fixed time, it is possible to prevent the communication load on the server 103 increasing due to sequential accesses of the server 103. The waiting time may be set by the user or waiting time information may be stored statically in the processing apparatus 102. Further, the time of the AC off state may be measured.

In step S402, the processing apparatus 102 makes a request for update data information to the server 103. For example, the processing apparatus 102 transmits the request by communicating with the server 103 through the communication unit 305. In step S402, identification information such as a model name of the processing apparatus 102 is transmitted to the server 103 together with a request for update data information.

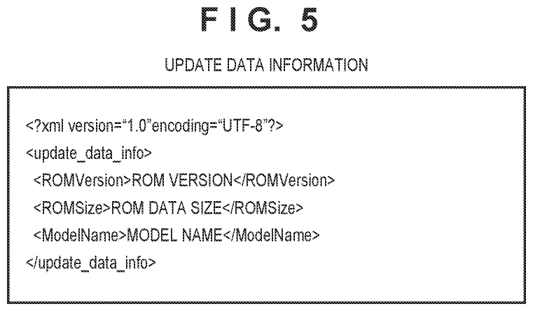

FIG. 5 is a diagram illustrating an example of update data information. The update data information is represented in XML format as illustrated in FIG. 5. Update data information includes information about the update data, not the update data itself. For example, as illustrated in FIG. 5, the update data information includes a ROM version, a ROM data size, and a model name corresponding to the update data.

In step S403, upon receiving the request for the update data information, the server 103 transmits the update data information corresponding to the processing apparatus 102 to the processing apparatus 102. The server 103 may authenticate the processing apparatus 102 before transmitting the update data information to the processing apparatus 102.

In step S404, the processing apparatus 102 receives update data information transmitted from the server 103 in step S403. Here, it may be determined whether or not the received update data information corresponds to the processing apparatus 102. When it is determined that the received update data information does not correspond to the processing apparatus 102, the received update data information is discarded, and the process of FIG. 4 is terminated. Further, the update data information transmitted from the server 103 in step S403 may be encrypted. If the update data information is encrypted, the processing apparatus 102 decrypts the update data information when it is received in step S404.

In step S405, the processing apparatus 102 compares the ROM version recorded in the update data information received in step S404 with the ROM version in the processing apparatus 102. If it is determined that the ROM version recorded in the update data information is newer than the ROM version in the processing apparatus 102, the process proceeds to step S406.

In step S406, the processing apparatus 102 stores information of “new update data available” in a non-volatile storage region such as the ROM 302. After storing the “new update data available” information in the processing apparatus 102 in step S406, the processing of FIG. 4 may be terminated or may be repeated from step S401.

In the present embodiment, the processing apparatus 102 requests the server 103 for the update data information and holds information on whether or not there is new update data in the server 103 based on the acquired update data information. If it is determined in step S405 that the ROM version recorded in the update data information is newer than the ROM version in the processing apparatus 102, the request of step S402 is repeated every fixed period of time. In this embodiment, with such a configuration, the processing apparatus 102 can recognize that there is new update data on the server 103 according to the timing at which the new update data is provided on the server 103.

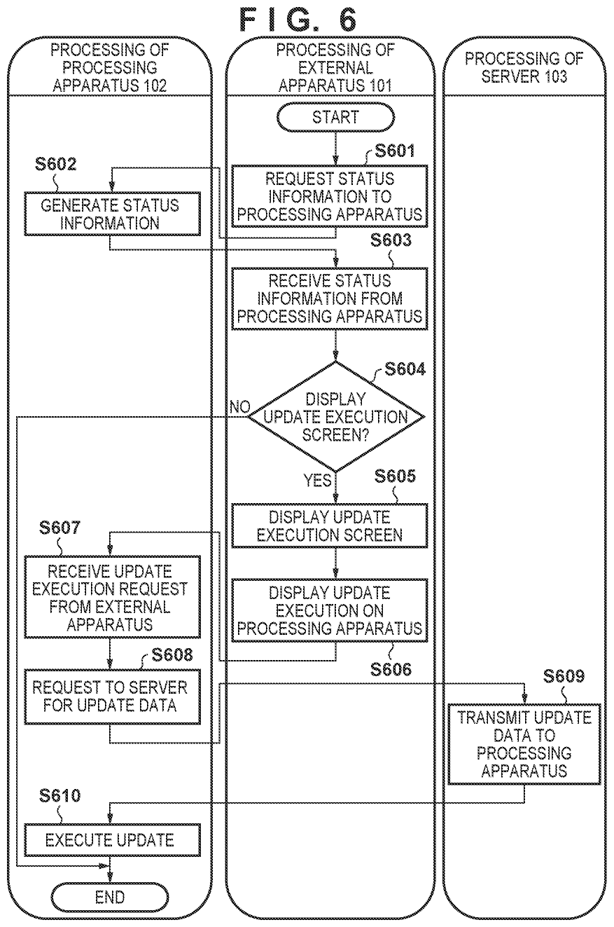

When an attempt is made to update the processing apparatus 102 in the processing of FIG. 6 described later, the ROM version recorded in the update data information acquired from the server 103 is compared with the ROM version in the processing apparatus 102. When the result of the comparison is that the ROM version in the processing apparatus 102 is the same as or older than the ROM version acquired from the server 103, the processing apparatus 102 stores the information of “no new update data” in the processing apparatus 102. That is, the “new update data available” information stored in step S406 is updated to the “no new update data” information by executing the update. With such a configuration, information indicating whether or not there is new update data can be appropriately updated according to the execution of the update in the processing apparatus 102.

Next, with reference to FIG. 6, a process in which the external apparatus 101 receives the status information of the processing apparatus 102 from the processing apparatus 102, requests the processing apparatus 102 to execute the update, and the processing apparatus 102 executes the update will be described.

In step S601, the external apparatus 101 makes a request to the processing apparatus 102 for the status information of the processing apparatus 102. Step S601 requests may be executed periodically at fixed intervals. The predetermined time may be set by the user of the external apparatus 101.

In step S602, upon receiving a request for status information from the external apparatus 101, the processing apparatus 102 generates status information of the processing apparatus 102, and transmits the status information to the external apparatus 101.

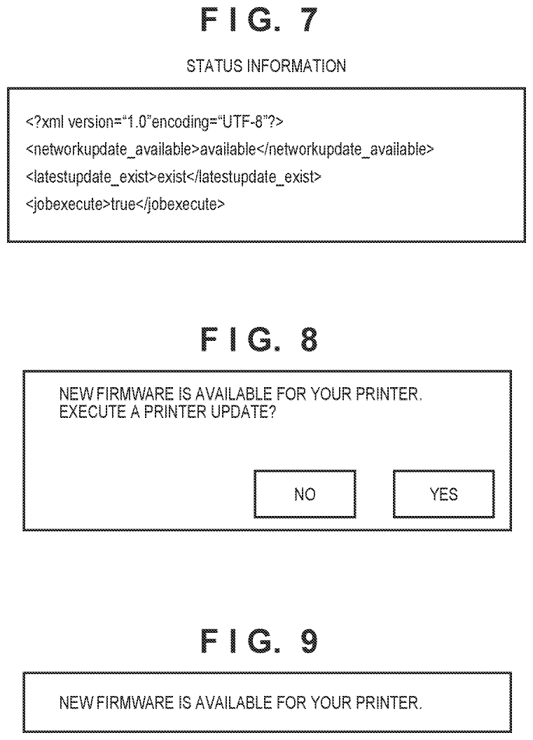

FIG. 7 is a diagram illustrating an example of status information of the processing apparatus 102. The status information of the processing apparatus 102 is represented in XML format as illustrated in FIG. 7. The <networkupdate_available> tag of FIG. 7 is a tag indicating whether or not the processing apparatus 102 is in a state in which it can execute an update. The value is “available” when the update can be executed, and the value is “not available” when the update cannot be executed.

The CPU 301 of the processing apparatus 102 determines that the processing apparatus 102 is in a state in which it can execute the update when all of the following conditions are satisfied.

Condition 1: If the processing apparatus 102 stores the “new update data available” information.

Condition 2: The update data can be received from the server 103.

Condition 3: The volatile memory of the processing apparatus 102 does not store data that must not be erased.

If the above conditions 1 to 3 are satisfied, the CPU 301 determines that the processing apparatus 102 is in a state in which the update can be executed.

Condition 1 is a necessary condition for executing the update because the update cannot be executed without the latest update data. Condition 2 is, for example, that the RAM 303 free space of the processing apparatus 102 is equal to or larger than the threshold value. Condition 2 is a requirement for executing the update because reception of the update data cannot be completed when the free space of the RAM 303 is low.

When the processing apparatus 102 is configured to perform a restart when an update is executed, the stored content of the RAM 303 may be erased when the update is executed. In the present embodiment, condition 3 is that the volatile memory of the processing apparatus 102 does not store data that must not be erased, so that it is possible to prevent the data from being erased inadvertently.

The conditions under which the update can be executed are not limited to the above. For example, the status of the connection of the apparatus to the processing apparatus 102 or a job execution status may be a condition. Further, it may be set whether or not to generate the <networkupdate_available> tag information of FIG. 7. Further, the <networkupdate_available> tag of FIG. 7 may be set so that the value of “not available” is always taken. It is possible to set so that the processing apparatus 102 does not generate tag information or so that a value of “not available” is taken at all times, so that, for example, display control can be executed so that the external apparatus 101 does not display a screen for executing an update of the processing apparatus 102. Such a setting may be set by, for example, an administrator of the processing apparatus 102.

The <latestupdate_exist> tag of FIG. 7 is a tag indicating whether or not “new update available” information is stored in the processing apparatus 102. If the “new update available” information is stored, the value is “exist”, and if the “new update available” information is set, the value is “not exist”. Further, it may be set whether or not to generate the <latestupdate_exist> tag information of FIG. 7. Further, the <latestupdate_exist> tag of FIG. 7 may be set so that the value of “not exist” is always taken. It is possible to set so that the processing apparatus 102 does not generate tag information or so that a value of “not available” is taken at all times, so that, for example, display control can be executed so that the external apparatus 101 does not display a screen indicating that there is new update data.

The <jobexecute> tag of FIG. 7 is a tag indicating whether or not the processing apparatus 102 is executing a job. If the job is being executed, the value is “true”, and if the job is not being executed, the value is “false”. Here, the job execution is, for example, a case in which the processing apparatus 102 executes printing.

Again, see FIG. 6. In step S603, the external apparatus 101 receives status information of the processing apparatus 102 generated in step S602. At this time, the status information of the processing apparatus 102 may be encrypted. When the encrypted status information of the processing apparatus 102 is received, the external apparatus 101 performs the decryption.

In step S604, the external apparatus 101 determines whether or not to display an update execution screen for executing an update of the processing apparatus 102. The external apparatus 101 makes a determination based on the status information of the processing apparatus 102 received in step S603. The determination of whether or not to display the update execution screen may be made based on the internal state of the external apparatus 101 in addition to the status information of the processing apparatus 102. For example, the execution may be performed based on the execution state of another application in the external apparatus 101. When it is determined in step S604 that the update execution screen is not to be displayed, the process of FIG. 6 is terminated. With such a configuration, the user can recognize that at the timing when the processing apparatus 102 is in the state in which an update can be executed. When it is determined that the update execution screen is to be displayed in step S604, in step S605, the external apparatus 101 displays the update execution screen on the display unit 210.

FIG. 8 is a diagram illustrating an exemplary update execution screen displayed in step S605. As illustrated in FIG. 8, the update execution screen displays a message that there is new update data of the processing apparatus 102 and whether or not to execute the update. The update execution screen may be displayed on the entire screen of the display unit 210 of the external apparatus 101, or may be displayed as a pop-up screen. The external apparatus 101 may clear the update execution screen when a network connection between the external apparatus 101 and the processing apparatus 102 is disconnected. The external apparatus 101 may clear the update execution screen when it is detected that the processing apparatus 102 is in sleep mode.

The condition for determining that the update execution screen for the processing apparatus 102 is displayed in step S604 is when the <networkupdate_available> tag of FIG. 7 is “available.” Alternatively, the condition for displaying the update execution screen may be satisfied when the <networkupdate_available> tag of FIG. 7 is “available”, and the <jobexecute> tag is “false”.

It is also possible to display a screen indicating that there is new update data for the processing apparatus 102, as illustrated in FIG. 9, with or without the update execution screen. For example, the screen illustrated in FIG. 9 may be displayed on the condition that the <latestupdate_exist> tag in FIG. 7 is “exist.”

In addition, a screen indicating that the state is such that the update of the processing apparatus 102 cannot be executed may be displayed on the display unit 210 of the external apparatus 101. For example, if the <networkupdate_available> tag of FIG. 7 is “not available”, a screen indicating that updating of the processing apparatus 102 cannot be executed may be displayed.

In step S606, the external apparatus 101 requests the processing apparatus 102 to execute the update upon receipt of an instruction from the user. For example, when the pressing of a “YES” button on the update execution screen of FIG. 8 is received, a request for execution of update is made to the processing apparatus 102.

In step S607, the processing apparatus 102 receives the update execution request from the external apparatus 101, and starts the processing for updating the processing apparatus 102. Incidentally, when the internal state of the processing apparatus 102 changes between step S602 to step S607 and it becomes impossible to execute the update, the processing of FIG. 6 ends. An example of this is a case where the processing apparatus 102 ceases to satisfy the above conditions 1 to 3. When the processing of FIG. 6 ends, the processing apparatus 102 transmits a response to the external apparatus 101 indicating that the update execution has failed. Also, when the update cannot be executed immediately because the processing apparatus 102 is executing a job, the execution of the update may be suspended until the job that is being executed is completed. At this time, the processing apparatus 102 transmits information indicating that the update is pending to the external apparatus 101. Further, the external apparatus 101 may be configured so that, when information indicating that an update is pending is received from the processing apparatus 102, the updating of the processing apparatus 102 can be stopped. For example, a screen that can accept an instruction on whether to abort an update of the processing apparatus 102 may be displayed on the display unit 210 of the external apparatus 101.

In step S608, the processing apparatus 102 makes a request for update data to the server 103. In step S608, identification information such as a model name of the processing apparatus 102 is transmitted to the server 103 together with a request for update data. Also, a request is made for the acquisition of update data information along with a request for update data. When an attempt is made to start the update execution, the ROM version recorded in the update data information acquired from the server 103 is compared with the ROM version in the processing apparatus 102. When the result of the comparison is that the ROM version in the processing apparatus 102 is the same as or older than the ROM version recorded in the update data information acquired from the server 103, the processing apparatus 102 stores “no new update data” information. Note that “no new update data” means that there is no new update data on the server 103. By the process of FIG. 4, the processing apparatus 102 stores the information of “new update data available”. After that, when the request for execution of the update is made from the external apparatus 101 by the processing of FIG. 6, the “new update data available” in the processing apparatus 102 is updated to “no new update data” and the processing of FIG. 4 is performed again. As the process of FIG. 4 is repeated, when the update data is updated in the server 103, step S406 then updates to “new update data available”.

In step S609, the server 103 transmits update data corresponding to the processing apparatus 102 to the processing apparatus 102. Note that the server 103 may authenticate the processing apparatus 102 before transmitting the update data to the processing apparatus 102. Note that the server 103 may encrypt the update data before transmitting the update data to the processing apparatus 102. In this case, the processing apparatus 102 decrypts the received update data.

In step S610, the processing apparatus 102 receives update data transmitted from the server 103 in step S609, and starts executing the update. Here, it may be determined in step S610 whether or not the received update data corresponds to the processing apparatus 102. When it is determined that the received update data does not correspond to the processing apparatus 102, the received update data is discarded, and the process of FIG. 6 is terminated.

After the update execution starts, the processing apparatus 102 may transmit the update execution result as a response to the external apparatus 101. Further, when the external apparatus 101 receives the response of the execution result of the update of the processing apparatus 102, the external apparatus 101 may clear the screen displayed in step S605. Further, the external apparatus 101 may display the result of executing the update of the processing apparatus 102 on the display unit 210. After execution of the update, the processing apparatus 102 may display the result of executing the update on the display unit 309. Further, the processing apparatus 102 may execute a restart when an update is executed.

As described above, by virtue of the present embodiment, the processing apparatus 102 can receive a request to execute an update at a timing when it is able to execute the update. The processing apparatus 102 acquires update data information from the server 103 at predetermined time intervals. With such a configuration, even in the case where update data gets updated on the server 103, the information of “new update data available” can be held in the processing apparatus 102 at an appropriate timing. Status information of the processing apparatus 102 is transmitted in response to a request from the external apparatus 101, and display control according to that information can be performed by the external apparatus 101.

### Second Embodiment

Hereinafter, a second embodiment will be described with reference to points different from the first embodiment. In the first embodiment, the update data information and the update data are held in the server 103. In the present embodiment, update data information and update data are held in the external apparatus 101 to which a request for execution of the update is made. The update data information and the update data may be generated by the external apparatus 101, or may be acquired from the server 103 in the first embodiment.

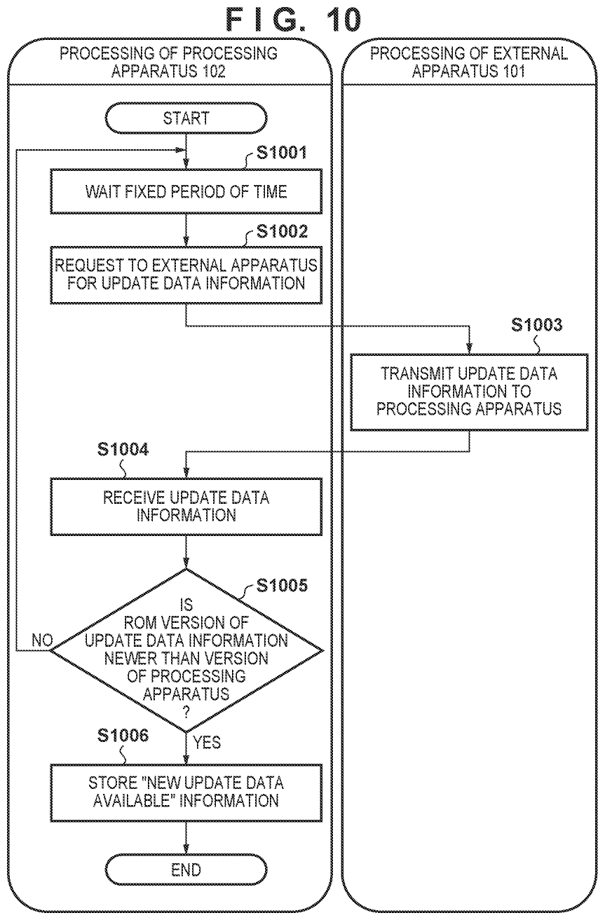

Referring to FIG. 10, a process in which the processing apparatus 102 acquires the update data information and stores the information of “new update data available” in the processing apparatus 102 will be described. The process of FIG. 10 may be initiated, for example, after the processing apparatus 102 is powered on.

In step S1001, the processing apparatus 102 waits for a fixed period of time prior to making a request to acquire update data information to the external apparatus 101. By waiting for a fixed time, it is possible to prevent the communication load on the external apparatus 101 from increasing due to sequential accesses of the external apparatus 101. The waiting time may be set by the user or waiting time information may be stored statically in the processing apparatus 102. Further, the time of the AC off state may be measured.

In step S1002, the processing apparatus 102 makes a request for update data information to the external apparatus 101. For example, the processing apparatus 102 transmits the request by communicating with the external apparatus 101 through the communication unit 305. In step S1002, identification information such as a model name of the processing apparatus 102 is transmitted to the external apparatus 101 together with a request for update data information. The update data information is, for example, information as illustrated in FIG. 5.

In step S1003, upon receiving the request for the update data information, the external apparatus 101 transmits the update data information corresponding to the processing apparatus 102 to the processing apparatus 102. Note that the external apparatus 101 may authenticate the processing apparatus 102 before transmitting the update data information to the processing apparatus 102.

In step S1004, the processing apparatus 102 receives update data information transmitted from the external apparatus 101 in step S1003. Here, it may be determined whether or not the received update data information corresponds to the processing apparatus 102. When it is determined that the received update data information does not correspond to the processing apparatus 102, the received update data information is discarded, and the process of FIG. 10 is terminated. Further, the update data information transmitted from the external apparatus 101 in step S1003 may be encrypted. If the update data information is encrypted, the processing apparatus 102 decrypts the update data information when it is received in step S1004.

In step S1005, the processing apparatus 102 compares the ROM version recorded in the update data information received in step S1004 with the ROM version in the processing apparatus 102. If it is determined that the ROM version recorded in the update data information is newer than the ROM version in the processing apparatus 102, the process proceeds to step S1006.

In step S1006, the processing apparatus 102 stores information of “new update data available” in a non-volatile storage region such as the ROM 302. After storing the “new update data available” information in the processing apparatus 102 in step S1006, the processing of FIG. 10 may be terminated or may be repeated from step S1001.

In the present embodiment, the processing apparatus 102 requests the external apparatus 101 for the update data information and holds information on whether or not there is new update data in the external apparatus 101 based on the acquired update data information. If it is determined in step S1005 that the ROM version recorded in the update data information is not newer than the ROM version in the processing apparatus 102, the request of step S1002 is repeated every fixed period of time. In this embodiment, with such a configuration, the processing apparatus 102 can recognize that there is new update data on the external apparatus 101 according to the timing at which the new update data is provided on the external apparatus 101.

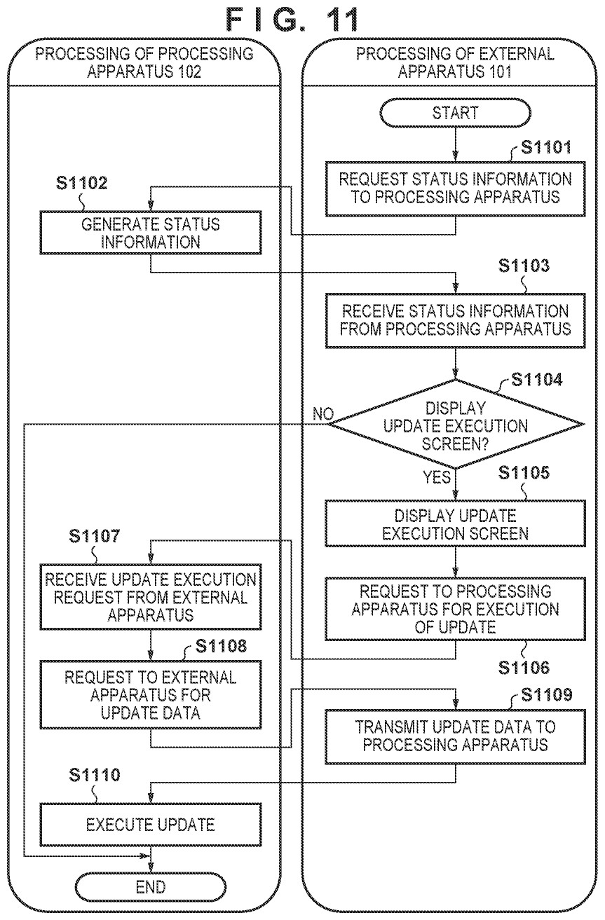

When an attempt is made to execute an update of the processing apparatus 102 in the processing of FIG. 11 described later, the ROM version recorded in the update data information acquired from the external apparatus 101 is compared with the ROM version in the processing apparatus 102. When the result of the comparison is that the ROM version in the processing apparatus 102 is the same as or older than the ROM version acquired from the external apparatus 101, the processing apparatus 102 stores the information of “no new update data” in the processing apparatus 102. That is, the “new update data available” information stored in step S1006 is updated to the “no new update data” information by executing the update. With such a configuration, information indicating whether or not there is new update data can be appropriately updated according to the execution of the update in the processing apparatus 102.

Next, with reference to FIG. 11, a process in which the external apparatus 101 receives the status information of the processing apparatus 102 from the processing apparatus 102 and then requests the processing apparatus 102 to execute the update, and the processing apparatus 102 executes the update will be described.

In step S1101, the external apparatus 101 makes a request to the processing apparatus 102 for the status information of the processing apparatus 102. Step S1101 requests may be executed periodically at fixed intervals. The predetermined time may be set by the user of the external apparatus 101.

In step S1102, upon receiving a request for status information from the external apparatus 101, the processing apparatus 102 generates status information of the processing apparatus 102, and transmits the status information to the external apparatus 101. The status information of the processing apparatus 102 is information as illustrated in FIG. 7.

In step S1103, the external apparatus 101 receives the status information of the processing apparatus 102 generated in step S1102. At this time, the status information of the processing apparatus 102 may be encrypted. When the encrypted status information of the processing apparatus 102 is received, the external apparatus 101 performs the decryption.

In step S1104, the external apparatus 101 determines whether or not to display an update execution screen for executing an update of the processing apparatus 102. The external apparatus 101 makes a determination based on the status information of the processing apparatus 102 received in step S1103. The determination of whether or not to display the update execution screen may be made based on the internal state of the external apparatus 101 in addition to the status information of the processing apparatus 102. For example, the execution may be performed based on the execution state of another application in the external apparatus 101. When it is determined in step S1104 that the update execution screen is not to be displayed, the process of FIG. 11 is terminated. With such a configuration, the user can be made to recognize that an update can be executed when the processing apparatus 102 is in the state in which an update can be executed. When it is determined that the update execution screen is to be displayed in step S1104, in step S1105, the external apparatus 101 displays an update execution screen as illustrated in FIG. 8 on the display unit 210. The update execution screen may be displayed on the entire screen of the display unit 210 of the external apparatus 101, or may be displayed as a pop-up screen. The external apparatus 101 may clear the update execution screen when a network connection between the external apparatus 101 and the processing apparatus 102 is disconnected. The external apparatus 101 may clear the update execution screen when it is detected that the processing apparatus 102 is in sleep mode.

The condition for determining that the update execution screen for the processing apparatus 102 is to be displayed in step S1104 is when the <networkupdate_available> tag of FIG. 7 is “available.” Alternatively, when the <networkupdate_available> tag of FIG. 7 is “available”, and the <jobexecute> tag is “false”, the condition for displaying the update execution screen may be determined to be satisfied.

It is also possible to display a screen indicating that there is new update data for the processing apparatus 102, as illustrated in FIG. 9, with or without the update execution screen. For example, the screen illustrated in FIG. 9 may be displayed on the condition that the <latestupdate_exist> tag in FIG. 7 is “exist.”

In addition, a screen indicating that the state is such that the update of the processing apparatus 102 cannot be executed may be displayed on the display unit 210 of the external apparatus 101. For example, if the <networkupdate_available> tag of FIG. 7 is “not available”, a screen indicating that updating of the processing apparatus 102 cannot be executed may be displayed.

In step S1106, the external apparatus 101 requests the processing apparatus 102 to execute the update upon receipt of an instruction from the user. For example, when the pressing of a “YES” button on the update execution screen of FIG. 8 is received, a request for execution of update is made to the processing apparatus 102.

In step S1107, the processing apparatus 102 receives the update execution request from the external apparatus 101, and starts the processing for updating the processing apparatus 102. Incidentally, when the internal state of the processing apparatus 102 changes between step S1102 to step S1107 and it becomes impossible to execute the update, the processing of FIG. 11 ends. When the processing of FIG. 11 ends, the processing apparatus 102 transmits a response to the external apparatus 101 indicating that the update execution has failed. Also, when the update cannot be executed immediately because the processing apparatus 102 is executing a job, the execution of the update may be suspended until the job that is being executed is completed. At this time, the processing apparatus 102 transmits information indicating that the update is pending to the external apparatus 101. Further, the external apparatus 101 may be configured so that, when information indicating that an update is pending is received from the processing apparatus 102, the updating of the processing apparatus 102 can be stopped. For example, a screen that can accept an instruction on whether to abort an update of the processing apparatus 102 may be displayed on the display unit 210 of the external apparatus 101.

In step S1108, the processing apparatus 102 makes a request for update data to the external apparatus 101. In step S1108, identification information such as a model name of the processing apparatus 102 is transmitted to the external apparatus 101 together with a request for update data. Also, a request is made for the acquisition of update data information along with a request for update data. When an attempt is made to start the update execution, the ROM version recorded in the update data information acquired from the external apparatus 101 is compared with the ROM version in the processing apparatus 102. When the result of the comparison is that the ROM version in the processing apparatus 102 is the same as or older than the ROM version recorded in the update data information acquired from the external apparatus 101, the processing apparatus 102 stores “no new update data” information. Note that “no new update data” means that there is no new update data on the external apparatus 101. By the process of FIG. 10, the processing apparatus 102 stores the information of “new update data available”. After that, when the request for execution of the update is made from the external apparatus 101 by the processing of FIG. 11, the “new update data available” in the processing apparatus 102 is updated to “no new update data” and the processing of FIG. 10 is performed again. As the process of FIG. 10 is repeated, when the update data is updated on the external apparatus 101, “new update data available” is updated in step S1006.

In step S1109, the external apparatus 101 transmits update data corresponding to the processing apparatus 102 to the processing apparatus 102. Note that the external apparatus 101 may authenticate the processing apparatus 102 before transmitting the update data to the processing apparatus 102. Note that the external apparatus 101 may encrypt the update data before transmitting the update data to the processing apparatus 102. In this case, the processing apparatus 102 decrypts the received update data.

In step S1110, the processing apparatus 102 receives update data transmitted from the external apparatus 101 in step S1109, and starts executing the update. Here, it may be determined in step S110 whether or not the received update data corresponds to the processing apparatus 102. When it is determined that the received update data does not correspond to the processing apparatus 102, the received update data is discarded, and the process of FIG. 11 is terminated.

After the update execution starts, the processing apparatus 102 may transmit the update execution result as a response to the external apparatus 101. Further, when the external apparatus 101 receives the response of the execution result of the update of the processing apparatus 102, the external apparatus 101 may clear the screen displayed in step S1105. Further, the external apparatus 101 may display the result of executing the update of the processing apparatus 102 on the display unit 210. After execution of the update, the processing apparatus 102 may display the result of executing the update on the display unit 309. Further, the processing apparatus 102 may execute a restart when an update is executed.

As described above, by virtue of the present embodiment, the processing apparatus 102 can receive a request to execute an update at a timing when it is able to execute the update. The processing apparatus 102 acquires update data information from the external apparatus 101 at predetermined time intervals. With such a configuration, even in the case where update data gets updated on the external apparatus 101, the information of “new update data available” can be held in the processing apparatus 102 at an appropriate timing. Status information of the processing apparatus 102 is transmitted in response to a request from the external apparatus 101, and display control according to that information can be performed by the external apparatus 101.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-214162, filed Dec. 23, 2020, which is hereby incorporated by reference herein in its entirety.

What is claimed is:

1. A processing apparatus capable of communicating with an external apparatus, the processing apparatus comprising:
a generation unit configured to generate status information indicating whether or not it is possible to execute an update of a control program for controlling the processing apparatus;
a transmission unit configured to transmit, to the external apparatus, the status information generated by the generation unit; and
a reception unit configured to receive a request for execution of the update from the external apparatus based on the status information transmitted by the transmission unit indicating that the execution of the update is possible.

2. The processing apparatus according to claim 1,
further comprising a first acquisition unit configured to acquire first information for determining whether or not to execute the update,
wherein the generation unit determines whether or not it is possible to execute the update based on the first information acquired by the first acquisition unit, and generates the status information based on a result of the determination.

3. The processing apparatus according to claim 2, wherein the status information includes information indicating whether or not there is update data of the control program.

4. The processing apparatus according to claim 2, wherein the first information includes information of update data of the control program.

5. The processing apparatus according to claim 4, wherein
the information of the update data is a version, and
the generation unit, in a case where a version included in the information of the update data is newer than a version already stored in the processing apparatus, generates the status information to indicate that execution of the update is possible.

6. The processing apparatus according to claim 2, wherein the first acquisition unit acquires the first information from an apparatus other than the external apparatus.

7. The processing apparatus according to claim 2, wherein the first acquisition unit acquires the first information from the external apparatus.

8. The processing apparatus according to claim 2,
further comprising a second acquisition unit configured to acquire second information for determining whether or not to execute the update, wherein
the generation unit determines whether or not it is possible to execute the update based on the second information acquired by the second acquisition unit, and generates the status information based on a result of the determination.

9. The processing apparatus according to claim 8, wherein the second information includes information indicating whether or not update data of the control program can be received from an external unit.

10. The processing apparatus according to claim 8, wherein the second information includes information indicating whether predetermined data is stored in a volatile memory of the processing apparatus.

11. The processing apparatus according to claim 2, wherein when the generation unit receives a request for the status information from the external apparatus, the generation unit generates the status information.

12. The processing apparatus according to claim 11, wherein the request for the status information from the external apparatus is received in a predetermined time interval.

13. The processing apparatus according to claim 11, wherein the acquisition of the first information by the first acquisition unit is performed irrespective of the request of the status information from the external apparatus.

14. The processing apparatus according to claim 2, further comprising a third acquisition unit configured to, when a request for execution of the update is received by the reception unit, acquire update data of the control program.

15. The processing apparatus according to claim 14, wherein the third acquisition unit acquires the update data from the external apparatus.

16. The processing apparatus according to claim 14, wherein the third acquisition unit acquires the update data from an apparatus other than the external apparatus.

17. The processing apparatus according to claim 14, further comprising an execution unit configured to, based on the update data acquired by the third acquisition unit, execute the update.

18. The processing apparatus according to claim 17,
further comprising a storage unit configured to store the first information acquired by the first acquisition unit, wherein
in a case where the update is executed by the execution unit, the first information is acquired by the first acquisition unit, and the first information already stored in the storage unit is updated.

19. A system comprising a first apparatus and a second apparatus, wherein
the first apparatus comprises:
a generation unit configured to generate status information indicating whether or not it is possible to execute an update of a control program for controlling the first apparatus;
a first transmission unit configured to transmit, to the second apparatus, the status information generated by the generation unit; and
a reception unit configured to receive a request for execution of the update from the second apparatus, and
the second apparatus comprises:
a display unit configured to display a screen for making a request for executing the update based on the status information transmitted by the first transmission unit indicating that the execution of the update is possible, and
a second transmission unit configured to, when an instruction for the execution of update is received in the screen for making the request for the execution of update displayed by the display unit, transmit to the first apparatus the request for the execution of the update.

20. A method executed in a processing apparatus capable of communicating with an external apparatus, the method comprising:
generating status information indicating whether or not it is possible to execute an update of a control program for controlling the processing apparatus;
transmitting to the external apparatus the generated status information; and
receiving a request for executing the update from the external apparatus based on the transmitted status information indicating that the execution of the update is possible.
